(19) United States
(12) Patent Application Publication
(10) Pub. No.: US 2011/0063223 A1
(43) Pub. Date: Mar. 17, 2011

(54) DISPLAY SYSTEM FOR DISPLAYING VIRTUAL KEYBOARD AND DISPLAY METHOD THEREOF

(75) Inventor: KUI-JUN WANG, Shenzhen City (CN)

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/647,400

(22) Filed: Dec. 25, 2009

(30) Foreign Application Priority Data
Sep. 11, 2009 (CN) 200910306903.1

(51) Int. Cl. G06F 3/02

(52) U.S. Cl. 345/168

(57) ABSTRACT

The present invention provides a display system for displaying a virtual keyboard and a display method used for the display system. The display system includes a project apparatus and a display apparatus, the project apparatus communicates with the display apparatus, the project apparatus comprises at least one infrared induction unit configured for transmitting infrared radio to a surface to generate virtual key points of the virtual keyboard and receiving infrared radio reflected by virtual key points of the virtual keyboard on the surface. Therefore, when one virtual key point is touched, the project apparatus acquires the key content information corresponding to the infrared induction unit and the display apparatus performs a function or displays a key content corresponding to the key content information.

### BACKGROUND

1. Technical Field

The disclosure relates to display systems and, more particularly, to a display system for displaying a virtual keyboard and a display method used for the display system.

2. Description of the Related Art

Generally speaking, some electronic devices, such as mobile phones, computers, and the like, include two input manners. One input manner is displaying a soft keyboard on a touch screen for a user. However, the touch screen implementing the soft keyboard function is very expensive. The other one is providing a solid keyboard for a user to input data. However, the solid keyboard holds a lot of space and it is inconvenient to bring the solid keyboard at all time with the user.

### BRIEF DESCRIPTION OF THE DRAWINGS

The components in the drawings are not necessarily drawn to scale, the emphasis instead being placed upon clearly illustrating the principles of the display system. Moreover, in the drawings, like reference numerals designate corresponding parts throughout the several views.

FIG. 1 is a schematic view of a project apparatus of a display system in accordance with an embodiment.

FIG. 2 is a schematic view of a virtual keyboard projected in accordance with an embodiment.

FIG. 3 is a schematic view of the project apparatus of FIG. 1 projecting the virtual keyboard of FIG. 2.

FIG. 4 is a block diagram of a display system in accordance with an embodiment.

FIG. 5 is a flowchart of a display method used for the display system of FIG. 4.

### DETAILED DESCRIPTION

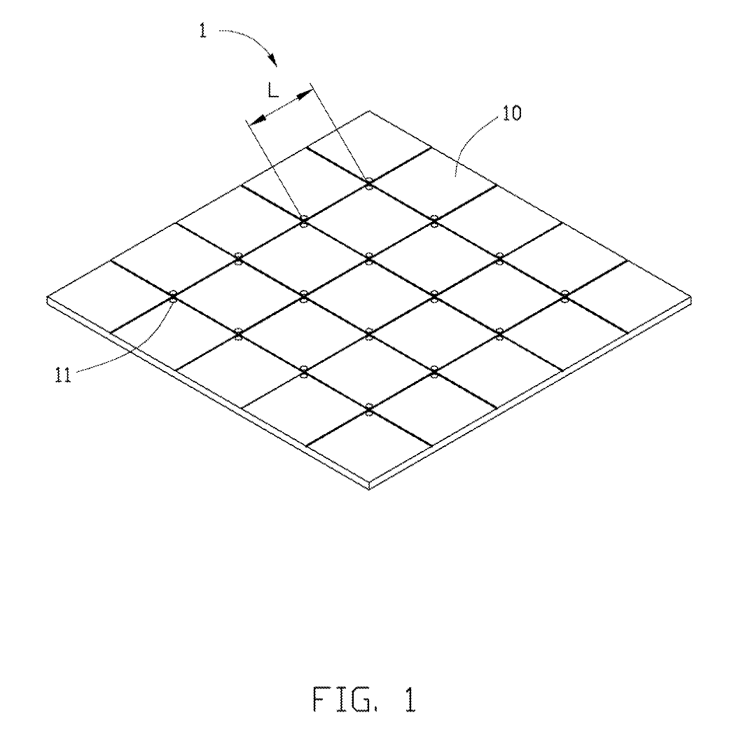

FIG. 1 is a schematic view of a project apparatus of a display system in accordance with an embodiment. The project apparatus 1 is a rectanglar shape and composed of a plurality of grids 10. In other embodiments, the project apparatus 1 can be in other shape, such as round, and so on. At one vertex of each grid 10 is positioned an infrared induction unit 11. In another embodiment, the infrared induction unit 11 can be positioned on other appropriate position of the grid 10, for example, at the center of the grid 10. An interval between two adjacent infrared induction units 11 is labeled “L” and the interval “L” is greater than a preset distance, for example, a width of a finger of a user.

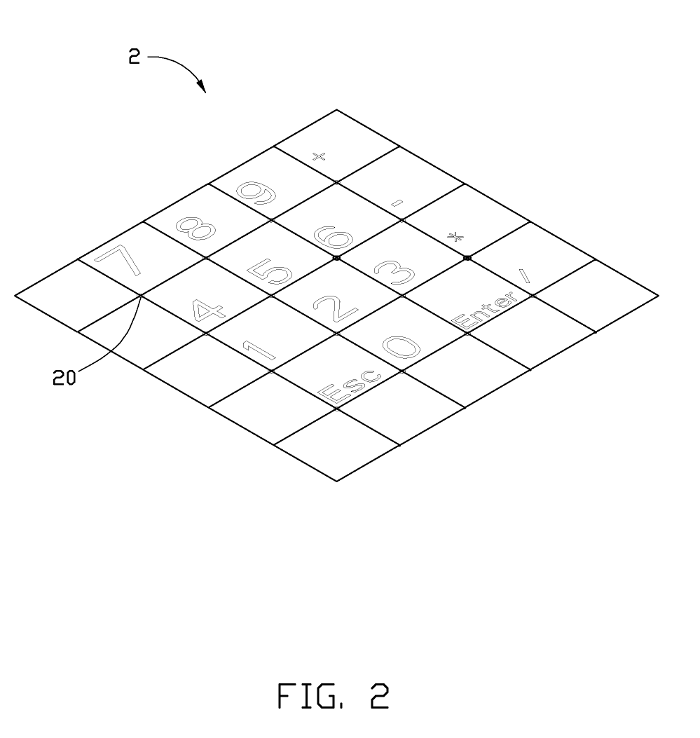

As shown in FIG. 2, the project apparatus 1 projects a virtual keyboard 2 on a surface. The shape of the virtual keyboard 2 is similar with the project apparatus 1. The infrared induction unit 11 on the vertex of each grid 10 projects infrared radio to the surface to obtain a virtual key point 20 on the virtual keyboard 2 and each virtual key point 20 is assigned corresponding display content. Because the interval between two adjacent virtual key points 20 is equal to “L”, which is greater than the width of a finger of the user, A mis-touch on the adjacent virtual key point 20 would be avoided when the user touches one virtual key point 20 of the virtual keyboard 2 on the surface.

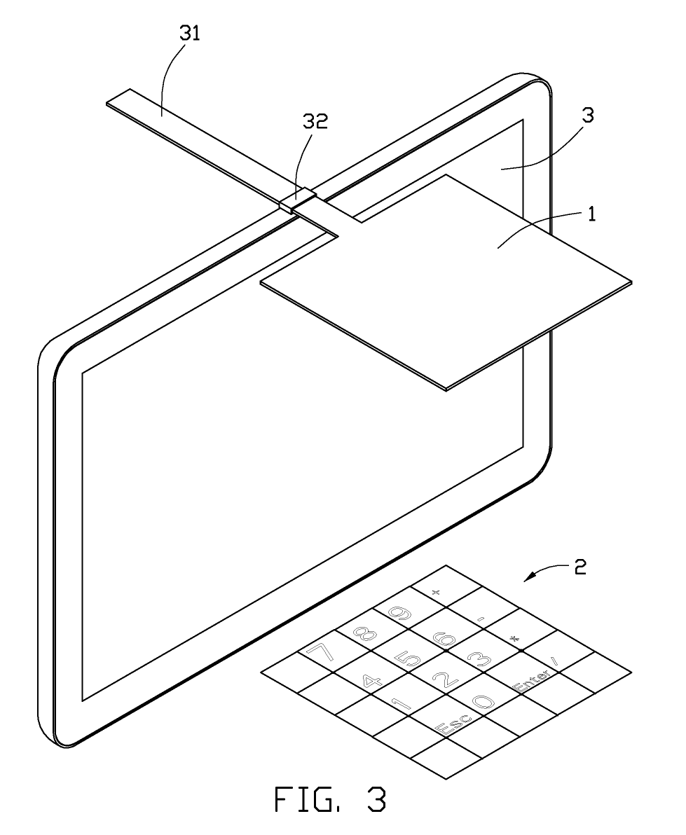

FIG. 3 is a schematic view of the project apparatus of FIG. 1 projecting the virtual keyboard of FIG. 2. A long arm 31 of the project apparatus 1 is extended through a hole 32 of the display apparatus 3, and can slide in the hole 32. The long arm 31 holds the project apparatus 1 substantially horizontal. Therefore, the project apparatus 1 vertically projects the virtual keyboard 2 on the surface.

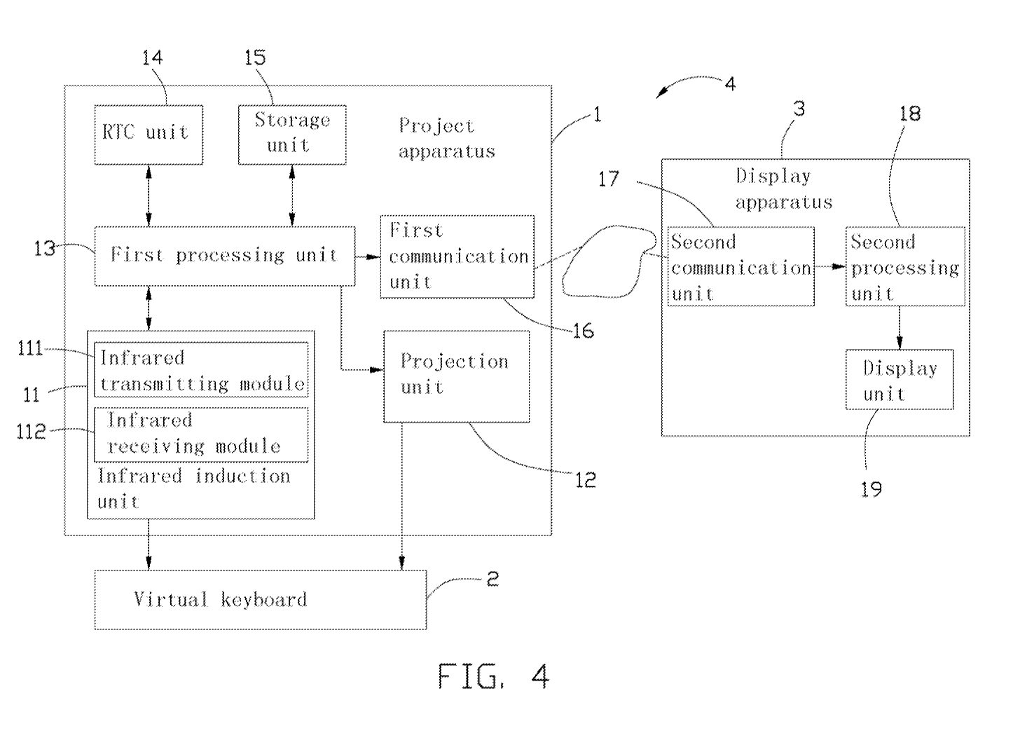

FIG. 4 is a block diagram of a display system in accordance with an embodiment. The display system 4 includes the project apparatus 1 and the display apparatus 3. The project apparatus 1 communicates with the display apparatus 3 via a wire or wireless manner. In this embodiment, the project apparatus 1 communicates with the display apparatus 3 via the wireless manner, such as Bluetooth. The project apparatus 1 includes at least one infrared induction unit 11, a projection unit 12, a first processing unit 13, a real-time control (RTC) unit 14, a storage unit 15, and a first communication unit 16.

The projection unit 12 is configured for projecting the virtual keyboard 2 on the surface vertically. Each infrared induction unit 11 has an ID, and is configured for transmitting infrared radio to the surface to generate the corresponding virtual key point 20 of the virtual keyboard 2 and receiving infrared radio reflected by the corresponding virtual key point 20 on the surface. At least one infrared induction unit 11 comprises a plurality of induction unit, in this embodiment, each infrared induction unit 11 includes an infrared transmitting module 111 and an infrared receiving module 112. The storage unit 15 is configured for storing key content information corresponding to each infrared induction unit 11, for example, the key content information of the first infrared induction unit 11 on the project apparatus 1 includes the digit “7” content. The RTC unit 14 is configured for calculating a time period between the time of transmitting the infrared radio to and the time of receiving the infrared radio from the virtual keyboard 2 in real time. The time period t=2s/v, s represents the distance from the infrared induction unit 11 to the corresponding virtual key point 20 and v represents a velocity of light.

When the virtual key point 20 is not touched, that means that the infrared radio from the corresponding infrared induction unit 11 is not baffled, the distance s is unchanged and the time period t is unchanged. When the virtual key point 20 is touched, that means that the infrared radio from the corresponding infrared induction unit 11 is baffled, the distance s becomes shorter and the time period t becomes smaller.

The first processing unit 13 is configured for judging whether the time period t of one infrared induction unit 11 becomes smaller. When the first processing unit 13 judges that the time period t of one infrared induction unit 11 is unchanged, the infrared radio from the infrared induction unit 11 is not baffled and the virtual key point 20 of the virtual keyboard 2 is not touched. When the first processing unit 13 judges that the time period t of one infrared induction unit 11 becomes smaller, that means that the infrared radio from the infrared induction unit 11 is baffled and the virtual key point 20 corresponding to the infrared induction unit 11 is touched, the first processing unit 13 acquires the key content information corresponding to the infrared induction unit 11 in the storage unit 15 and controls the first communication unit 16 to send a wireless signal of the key content information to the display apparatus 3.

The display apparatus 3 further includes a second communication unit 17, a second processing unit 18, and a display unit 19. The second communication unit 17 is configured for receiving the wireless signal of the key content information from the first communication unit 16 and transmitting the received wireless signal to the second processing unit 18. The second processing unit 18 is configured for processing the wireless signal and performing a function corresponding to the key content information, or controlling the display unit 19 to display a key content corresponding to the key content information.

For example, when the digit “7” virtual key point 20 on the virtual keyboard 2 is touched, the distance s from the digit “7” virtual key point 20 to the corresponding infrared induction unit 11 becomes shorter and the time period t of the infrared induction unit 11 becomes smaller. The first processing unit 13 acquires the key content information corresponding to the infrared induction unit 11 in the storage unit 15 to the display apparatus 3. The second processing unit 18 controls the display unit 19 to display the digit “7.”

Therefore, when one virtual key point 20 on the virtual keyboard 2 is touched, the project apparatus 1 acquires the key content information corresponding to the infrared induction unit 11 in the storage unit 15 and the display apparatus 3 performs a function or displays a key content corresponding to the key content information.

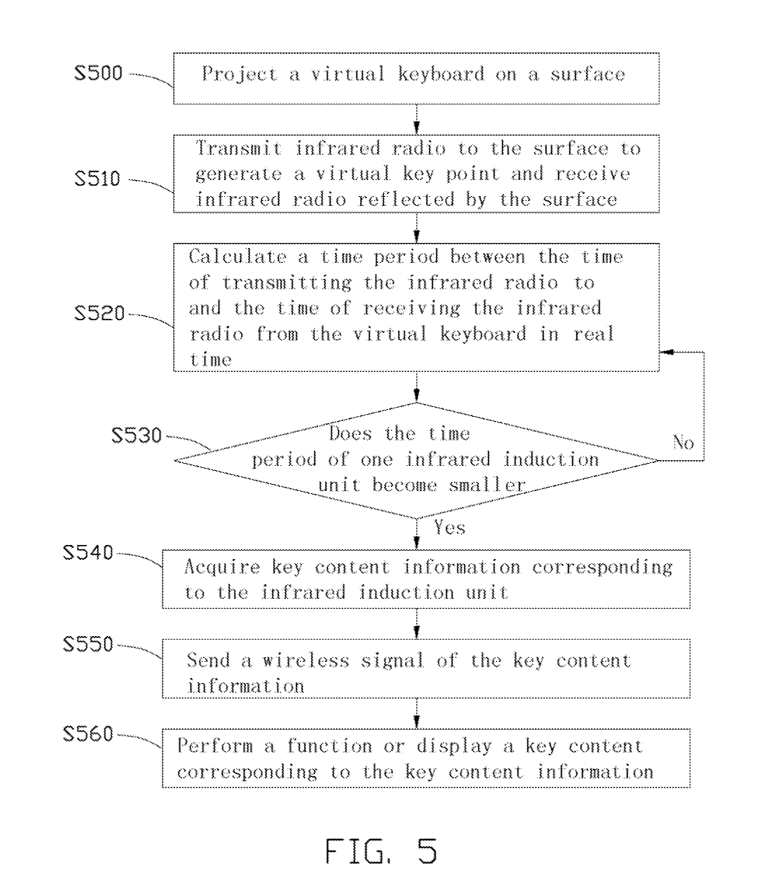

FIG. 5 is a flowchart of a display method adapted for the display system of FIG. 4. In step S500, the projection unit 12 of the project apparatus 1 vertically projects the virtual keyboard 2 on the surface. In step S510, each infrared induction unit 11 transmits the infrared radio to the surface to generate the virtual key point 20 and receives the infrared radio reflected by the virtual keyboard 2 in real time. In step S520, the RTC unit 14 calculates the time period between the time of transmitting the infrared radio to and the time of receiving the infrared radio from the virtual keyboard 2 in real time. In step S530, the first processing unit 13 of the project apparatus 1 judges whether the time period of one infrared induction unit 11 becomes smaller.

If the first processing unit 13 judges that the time period of each infrared induction unit 11 is unchanged, that means that the virtual keyboard 2 is not touched, the procedure returns to step S520. If the first processing unit 11 judges that the time period of one infrared induction unit 11 becomes smaller than the time period would otherwise be without the virtual keyboard 2 being touched, in step S540, the virtual key point 20 corresponding to the infrared induction unit 11 on the virtual keyboard 2 is touched and the first processing unit 13 acquires the key content information corresponding to the infrared induction unit 11 from the storage unit 15. In step S550, the first communication unit 16 sends the wireless signal of the key content information to the display apparatus 3.

In step S560, the second communication unit 17 receives the wireless signal of the key content information, and the second processing unit 18 processes the wireless signal and performs the function corresponding to the key content information, or controls the display unit 19 to display the key content corresponding to the key content information.

It is understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A display system for displaying a virtual keyboard, comprising:
a display apparatus;
a project apparatus communicating with the display apparatus, the project apparatus comprising:
a projection unit configured for projecting the virtual keyboard on a surface;
at least one infrared induction unit configured for transmitting infrared radio to the surface to generate corresponding virtual key points on the virtual keyboard and receiving infrared radio reflected by the corresponding virtual key points of the virtual keyboard on the surface;
a storage unit configured for storing key content information corresponding to each infrared induction unit;
a real-time control (RTC) unit configured for calculating a time period between the time of transmitting the infrared radio to and the time of receiving the infrared radio from the virtual keyboard in real time;
a processing unit configured for judging whether the time period of one infrared induction unit becomes smaller from the RTC unit; and
a communication unit configured for sending a signal to the display apparatus;
wherein when the processing unit judges that the time period of one infrared induction unit becomes smaller, the processing unit acquires key content information corresponding to the infrared induction unit from the storage unit and controls the communication unit to send a signal of the key content information to the display apparatus, and the display apparatus processes the signal of the key content information and performs a function corresponding to the key content information, or displays a key content corresponding to the key content information.

2. The display system for displaying a virtual keyboard as recited in claim 1, wherein each infrared induction unit further comprises an infrared transmitting module and an infrared receiving module.

3. The display system for displaying a virtual keyboard as recited in claim 1, wherein the project apparatus is a rectanglar shape and composed of grids, at least one infrared induction unit comprises a plurality of induction unit, and one of the plurality of infrared induction units is positioned at a vertex of each grid.

4. The display system for displaying a virtual keyboard as recited in claim 3, wherein the interval between two adjacent infrared induction units is greater than a width of a finger.

5. The display system for displaying a virtual keyboard as recited in claim 1, wherein the display apparatus comprises a second communication unit, a second processing unit, and a display unit, the second communication unit is configured for receiving the signal from the project apparatus, the second processing unit is configured for processing the signal and performing the function, or controlling the display unit to display the key content.

6. The display system for displaying a virtual keyboard as recited in claim 1, wherein the communication unit is configured for sending the signal to the display apparatus via a wireless manner.

7. The display system for displaying a virtual keyboard as recited in claim 1, wherein the communication unit is configured for sending the signal to the display apparatus via a wire manner.

8. A display method for a display system for displaying a virtual keyboard, wherein the display system comprises a project apparatus and a display apparatus, the project apparatus communicates with the display apparatus, the project apparatus comprises at least one infrared induction unit configured for transmitting infrared radio to a surface to generate virtual key points of the virtual keyboard and receiving infrared radio reflected by virtual key points of the virtual keyboard on the surface, the method comprising:
storing key content information corresponding to each infrared induction unit;
projecting the virtual keyboard on the surface;
transmitting the infrared radio to the surface and receiving the infrared radio reflected by on the surface;
calculating a time period between the time of transmitting the infrared radio to and the time of receiving the infrared radio from the virtual keyboard in real time;
judging whether the time period of one infrared induction unit becomes smaller;
if the time period of one infrared induction unit becomes smaller, acquiring the key content information corresponding to the infrared induction unit;
sending a signal of the key content information; and
performing a function or displaying a key content corresponding to the key content information.

9. The display method as recited in claim 8, wherein each infrared induction unit further comprises an infrared transmitting module and an infrared receiving module.

10. The display method as recited in claim 8, wherein the project apparatus is a rectanglar shape and composed of grids, the at least one infrared induction unit comprises a plurality of infrared induction units, and one infrared induction unit is positioned at a vertex of each grid.

11. The display method as recited in claim 10, wherein the interval between two adjacent infrared induction units is greater than a width of a finger.

12. The display method as recited in claim 8, wherein the step of sending a signal of the key content information is sending the signal via a wireless manner.

13. The display method as recited in claim 8, as recited in claim 1, wherein the step of sending a signal of the key content information is sending the signal via a wire manner.
